(19) United States
(12) Patent Application Publication
(10) Pub. No.: US 2013/0311199 A1
(43) Pub. Date: Nov. 21, 2013

(54) SKILL EVALUATION

(71) Applicant: Ram Srikanth Mirlay, Bangalore (IN)

(72) Inventor: Ram Srikanth Mirlay, Bangalore (IN)

(21) Appl. No.: 13/981,925

(22) PCT Filed: Jan. 30, 2012
(86) PCT No.: PCT/IN12/00062

§ 371 Date: Jul. 26, 2013

(30) Foreign Application Priority Data
Jan. 30, 2011 (IN) 3630/CHE/2010

(51) Int. Cl. G06Q 10/06; G06Q 50/22

(52) U.S. Cl. CPC G06Q 10/06393; G06Q 50/22
USPC 705/2

(57) ABSTRACT

The present invention provides a system to evaluate of Tissue Manipulation Events (TMEs) performed on a subject, by a practitioner and providing a corresponding ranking-score thereof. The system includes a contour image capturing and recording devices adapted to capture and record, in real time, the contours of a surgical tool and a tissue and tissue manipulating events of a subject, which are connected to a data receiver for receiving the vector image data. At least a database including bench-mark surgical parameters, tissue and tool parameters are connected to the system. A processor coupled to the data receiver and the databases and configured to convert the vector image data (raw image) into pixelated frames, evaluate tissue manipulation events and generate a performance score for the task performed on the subject. The present invention also provides a method for evaluation of manual skills in tissue manipulating events performed.

### TECHNICAL FIELD

The present invention generally pertains to evaluation of manual skills, and more particularly to a system and method to evaluate Tissue Manipulation Events (TMEs) performed on a subject by a practitioner and providing a corresponding ranking-score thereof.

### BACKGROUND OF THE INVENTION

Performance of a task involving a skill, such as surgery, is evaluated to objectively assess the skills of a person, while performing the surgery.

Manual skill is now widely recognized as an important aspect of training in surgery. However, measurement of the skill of a surgeon has in the past been rather subjective in nature, relying on the judgment of experts in the analysis of videotapes.

Typical systems and methods of evaluating the performance skills are fraught with human errors, often imprecise and not useful for repeated evaluations.

### OBJECTS OF THE PRESENT INVENTION

The primary object of the present invention is to provide a system and method to render a ranking-score on human skills associated with Tissue Manipulation Events (TMEs) performed on a subject.

Another object of the present invention is to provide a system and method to render a ranking-score on human skills associated with Tissue Manipulation Events (TMEs) performed on a subject, in which a total number of touch attempts made by a user in performing TMEs are recorded.

Still another object of the present invention is to provide a system and method to render a ranking-score on human skills associated with Tissue Manipulation Events (TMEs) performed on subject, in which a total number of deviations from a benchmarked path, made by a user in performing TMEs, is recorded.

Yet another object of the present invention is to provide a system and method to render a ranking-score on human skills associated with Tissue Manipulation Events (TMEs) performed on subject, in which a time expended by a user in performing TMEs is recorded.

### BRIEF DESCRIPTION OF THE DRAWINGS

Various aspects and attendant advantages of one or more exemplary embodiments and modifications thereto will become more readily appreciated as the same become better understood by reference to the following detailed description, when taken in conjunction with the accompanying drawings, wherein:

FIG. 1 is a block drawing of the system of the present invention to provide a ranking-score on Tissue Manipulation Events (TMEs).

FIG. 2 is a raw video recording of a surgical procedure.

FIG. 3 is fragmented frames of raw video recording.

FIG. 4 is a perspective view of pixelated contour determination of a tool.

FIG. 5 is a perspective view of pixelated contour determination of a tool, depicting the movement of a pointer.

FIG. 6 is a perspective view of the contour vector of a tool.

FIG. 7 is a perspective view of pixelated contour determination of a tissue.

FIG. 8 is a picture depicting surgery tissue area.

FIG. 9 is a picture depicting a tool selected for the surgery.

FIG. 10 is a picture depicting an incision on a tissue.

FIG. 11 is a picture depicting a combination of tools, tissue, incision and retraction.

FIG. 12 is a perspective view of a benchmarked surgical path and deviated surgical path.

FIG. 13 is a flow diagram for the method of the present invention.

FIG. 14 is a flow diagram for tool identifier sequence.

FIG. 15 is a flow diagram for tissue identifier sequence.

FIG. 16 is a flow diagram for tissue manipulation events.

### SUMMARY OF THE PRESENT INVENTION

The present invention provides a system to evaluate Tissue Manipulation Events (TMEs) performed on a subject by a practitioner and providing a corresponding ranking-score thereof. The system includes contour image capturing and recording devices adapted to capture and record, in real time, the contours of a surgical tool and a tissue and tissue manipulating events of a subject, which are connected to a data receiver for receiving vector image data. At least a database including bench-mark surgical parameters, tissue and tool parameters is connected to the system. A processor coupled to the data receiver and the database(s) and configured to convert the vector image data (raw image) into pixelated frames, evaluate tissue manipulation events and generate a performance score for the task performed on the subject is provided. The present invention also provides a method for evaluation of manual skills in Tissue Manipulation Events (TMEs) performed on a subject.

### DETAILED DESCRIPTION OF THE INVENTION

The present invention provides a system and a method for evaluating Tissue Manipulation Events (TMEs) such as surgeries, performed on a subject and rendering a corresponding ranking-score on the exhibition of manual skills by a practitioner while undertaking the Tissue Manipulation Events (TMEs). The evaluation of the manual skills in the execution of Tissue Manipulation Events (TMEs) of the practitioner involves an objective and accurate assessment of parameters such as hand dexterity, precise movements of surgical tools, economy in total number of tissue-touch attempts (TTAs) by surgical tools, deviation from a pre-defined surgical path, time taken for tissue manipulation etc., while performing a surgical procedure on the subject.

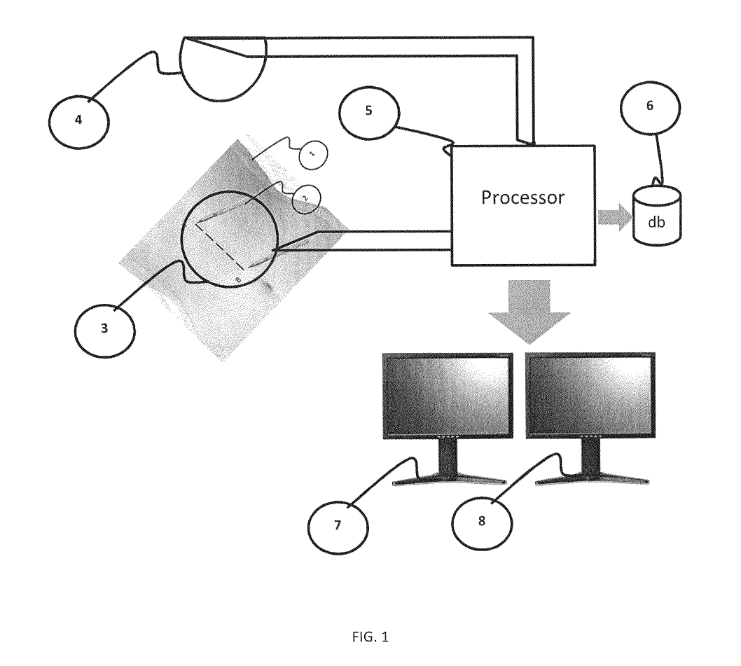

The present invention also provides a system to render a ranking-score on human skills associated with Tissue Manipulation Events (TMEs) performed on the subject. The broad system architecture of the present invention is as provided in FIG. 1. A subject 1 selected for the surgical procedure is identified. The surgical tools 2 are designated for TMEs. Contour Identification Devices (CIDs) 3 and 4 are positioned at various angles to focus on the subject 1 and also to record the movements of the surgical tools 2 in the hands of the practitioner (not shown in the FIG. 1) The preferred angles for the CIDs are substantially perpendicular to each other of which one CID is co-axial to the subject 1. The CIDs are opto-electronic devices such as cameras, CMOS sensors, Light Dependent Resistors (LDR), chromatic sensors etc., having desired optical zoom, speed, High Definition Resolution, movement sensing etc. The axial camera is arranged to record tissue manipulation movements of practitioner's surgical tool, held in hands in two-dimensional plane i.e. length and breadth planes, in relation to the subject. The axial camera captures movements of the instrument in the hands of the practitioner, in relation to the subject, in x and y axes. The tissue manipulation events include incision, tissue expansion, holding of tissues with forceps etc. Whereas, the obliquely positioned camera, captures the tissue manipulation movements of the instrument in z-axis, in relation to the subject, albeit but from different angular positions. The obliquely-positioned camera is used capture vertical, depth and aerial movements of the instrument. In other words, the combination of axial and oblique cameras helps in capturing Tissue Touch Attempts (TTAs) of the instrument, during the course of a surgical procedure.

The input video images that are captured can be in any encoded or raw video formats such as, Flash Video Format (.flv), AVI Format (.avi), Quicktime Format (.mov), MP4 Format (.mp4), Mpg Format (.mpg), Windows Media Video Format (.wmv), 3GP File Extension (.3gp), 3GP File Extension (.3gp), 3GP File Extension (.3gp), Advances Streaming Format (.asf), Advances Streaming Format (.asf), 3GP File Extension (.3gp), Real Media Format (.rm), Flash Movie Format (.swf), The RealVideo Format (.ra/.rm/.ram) etc.

A digital processor 5, which is loaded with modules such as tool identifier, tissue identifier and tissue manipulation events executables, is connected to CIDs. The processor 5 is arranged to compute the various stages of TMEs, by drawing an input of raw video recording of surgical procedure and processing the same in conjunction with databases 6 having Tissue and Tool data and benchmarking data. The system of the present invention evaluates the Tissue Manipulation Events (TMEs) performed on a subject, by a practitioner and provides a corresponding ranking-score thereof through display devices 7 and 8 which are connected to the digital processor 5.

In evaluating the manual skills in a surgical procedure, the evaluation of Tissue Manipulation Events (TMEs) such as incision, retraction, cauterization, heamostasis, diathermy, dissection, excision, injection, implantation, surface marking and other similar tissue manipulations performed on the subject by the practitioner is made. In these procedures, the significant events like total number of tissue touch attempts, deviation and total time taken assume significance in evaluating the surgical skills.

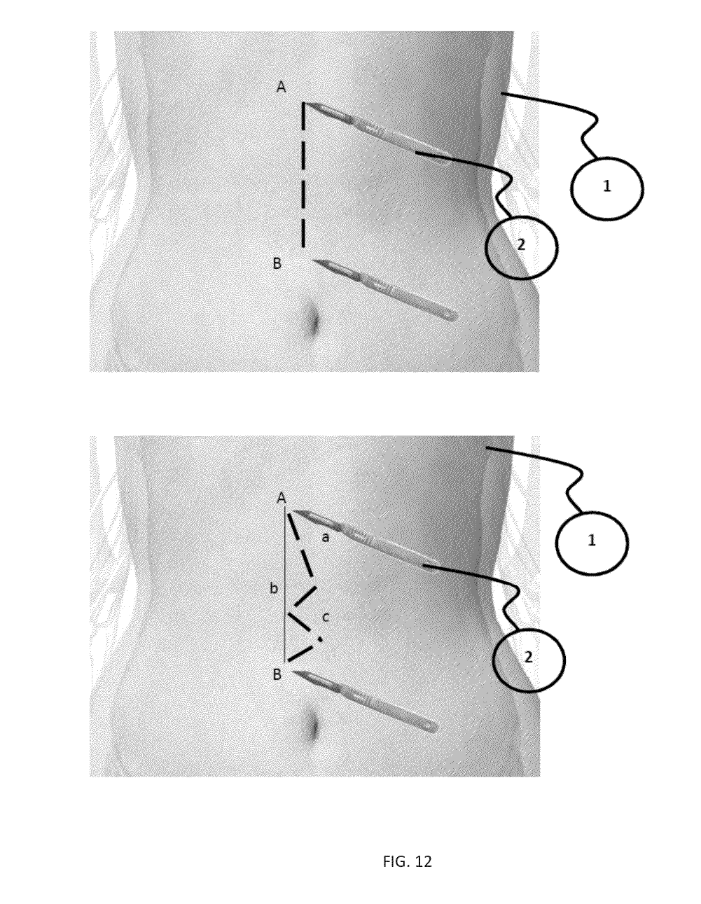

For instance, 1 TME can be defined as the starting time and space point, when and where the tool touches the tissue and moves to manipulate it, till that particular manipulation is completed. This event is shown in FIG. 12, in an exemplary manner from point A to B, which is an ideal and most preferred scenario for a skilled surgeon.

The time for TME is calculated as the ratio of total time taken by the practitioner to finish one TME over the benchmarked time for 1 TME.

Similarly, the method of the present invention also identifies a surgical procedure performed by an unskilled person, resulting in a deviation of the surgical path as shown in FIG. 12.

Any such deviations are measured as in the following manner.

TME Scoring Method

A→a=1

a→b=1

b→c=1

c→B=1

Total TME Score=4

Time Taken=15 secs
Benchmark time 5 secs
The TME time ratio 15/5=3
Therefore, TME time score is 3 and hence the resulting in a total score of 3+4=7.

Calculation of Aab and bcB areas (deviation) is as shown in FIG. 12
ΔAab=1 point
ΔbcB=4 points
Total=5 points for deviation

Therefore, the total score for this TME=7+5=12 points

The weightage of points for evaluating need not necessarily be numerically linear and can be decided upon by the expert panel of surgeons, who will base it upon its frequency and risks the deviations pose to the subject and other factors such as local, geographic tissue and organ peculiarities.

The time taken T_{A} for TME as shown in FIG. 12, is the time of tool contact with A till it reaches point B and disconnects with the tissue.

The time of tool contact with tissue A and including the immediate next disconnect at ‘a’ can be termed T_{A} 1. This part of the TME can be termed as TME 1.

A→a=TME 1=T_{A} 1

a→b=TME 2=T_{A} 2

b→c=TME 3=T_{A} 3

c→B=TME 4=T_{A} 4

The tissue-tool contact time TB for each TME as shown in FIG. 12, is the time taken for the tool to move from A to a only. It excludes the time taken by the practitioner from tool-disconnect to tool-reconnect with tissue.

The intermediate time TC is the time taken by the practitioner between the tissue manipulation events. In other words, it is time when practitioner disconnects tool from tissue at ‘a’ and reconnects tool from tissue at ‘a’. Similarly, at ‘b’ and ‘c’ as shown in FIG. 12.

The total time TD is the time taken for the complete surgical procedure as shown in FIG. 12 from point A to B.

With TA to TD data in hand (TME data) it empowers the expert panel of surgeons with data directly reflecting surgical performance of the practitioner. The expert panel may set ranges for the scoring or ranking of the points based on TME and TA to TD.

The basis of such decisions provides a narrow, moderate, or lax scoring method.

In a general surgery, the number of steps for instance in an appendix surgery, are skin incision, muscle separation, peritoneal incision & separation, isolation of appendix/dissection around appendix, ligature of neck/root of appendix, removal of appendix, suture of peritoneum, muscle layer suturing and skin suturing.

The tools for each step will vary. They can be broadly classified under the following heads.

1. Incision or cutting tools: blades/knives/scissors

2. Holding and separating tools: forceps

3. Hemostatic tools: ligature, cautery and mops

4. Retractors/Separators

5. Dissection and manipulation

The method of the present invention can be suitably calibrated for recognizing any of the tools used.

The expression “Deviation” as used in the present invention is the difference between a benchmarked tissue manipulation and subject's tissue manipulation in geography, as recorded in the video.

The subject video may have more number of TMEs. However, if the surgical step is in line with benchmark the deviation is considered as NIL.

The scoring for deviation, in one suggested method, is to use the measured area of deviation. The expert panel of surgeons or practitioners (EPoS) may decide the variability permitted per step and also the penalty scoring for the extent of deviation beyond the limits they set.

The deviation may also result in complication in the surgery, which refers to an unplanned, damage to tissue or organ or body which has a detrimental effect.

As these are outside the purview of the benchmark surgery and recognized by the method of the present invention as “out of benchmark”, and an alert is generated, which is in the form of a penalty scoring, per complication. In other words, ‘x’ number is added to the final score before ranking is provide.

In addition, in the system of the present invention an additional audio-visual complication correcting and suggesting mechanism can be incorporated.

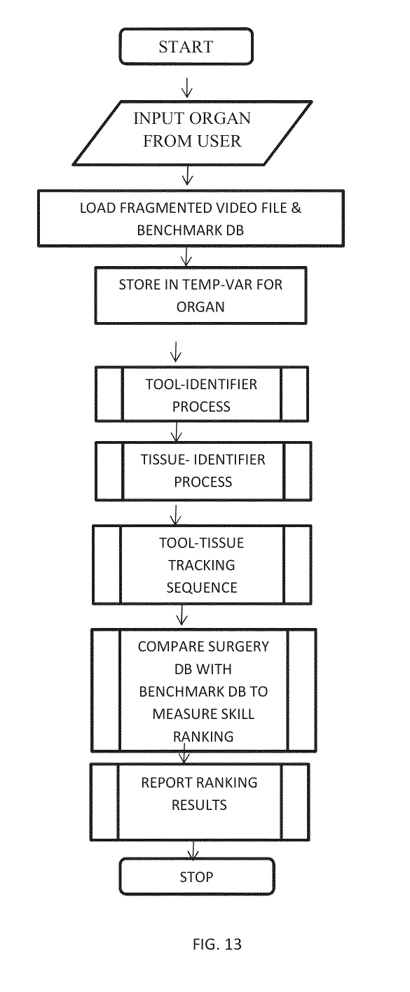

In an aspect of the present invention, a method to evaluate the Tissue Manipulation Events (TMEs) performed on the subject by the practitioner and the corresponding ranking-score thereof is now described in the following main steps and in accordance with FIG. 13 of the accompanied drawings.

### Stage: 1—Preparation of a Raw Image File

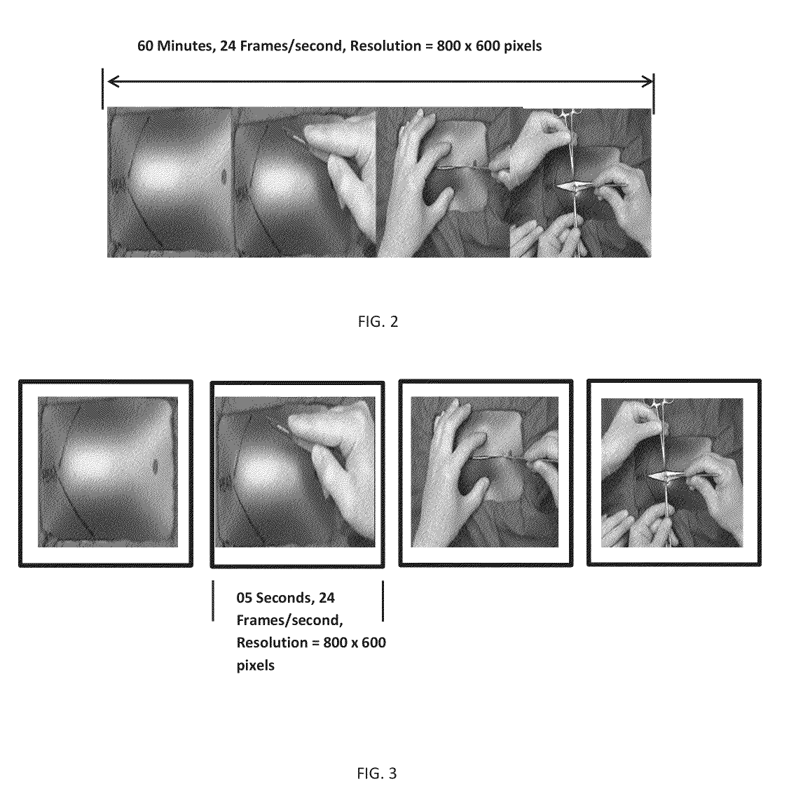

By referring to FIG. 2, in an aspect of the present invention, digitally-recorded video image file(s), incorporating the surgical procedure performed by the practitioner, is considered as an input for the evaluation of the manual skills while undertaking Tissue Manipulative Events (TMEs) on the subject. The digitally-recorded video images, which are captured and recorded, in real time, preferably in high-definition formats, such as Standard Definition (NTSC & PAL) are used for recording the TMEs. The recorded video images will include a sequential record of the various stages of the TMEs performed by the practitioner, in real time, on the selected subject, commencing from the selection of tissue of the subject to the completion of the tissue manipulation. The digitally-recorded video images capture details of TMEs, as shown in FIG. 2, such as selection of tissue manipulation area, types of surgical tools, various steps undertaken by the practitioner in accomplishing the tissue manipulation, total number of tissue-touch attempts made by the practitioner and the extent of the usage of tissue space, while conducting the surgical procedure.

The digitally-recorded video images are captured by recording devices, having capabilities to sense, capture and record the external contours of the selected tissue of the subject and the corresponding surgical tools used in the process of tissue manipulation. The devices used to capture and record the external contours in the method of the present invention are Contour Identification Devices (CIDs), which are opto-electronic devices, which can capture and store digitally, the images, in real time.

The CIDs are adopted to capture contours of the selected surgical tool, which are programmed to focus, read and trace contour set (x, y & z coordinates) of the selected surgical device, in real time. The CIDs are allowed to focus on the selected surgical tool and the corresponding relative coordinates along x, y & z axes of the selected surgical tool (external contours) are identified and stored. The CIDs are disposed to focus from different angular positions, preferably from axial and oblique positions, on to the selected subject, in order to capture the external contours of the surgical device.

The CIDs are adapted to capture and record the tissue manipulating events, under any conditions such as variable light, focal lengths etc.

Similarly, the CIDs are allowed to focus on the selected tissue of the organ to capture the external contours of the tissue.

### Stage 2—Fragmentation of the Raw Video File Based on Tool and Tissue Contour Data

As shown in FIG. 3, the raw image data of tool and tissue contours, from the video file are fragmented based on the factors such as function of time, number of tools used, tissue-density variation and on other relevant factors that are desirable to obtain in the fragmented data. The tool and tissue contour data, which are captured in the form of a raw-image format in the video file, are converted or fragmented into pixels and stored as pixelated fragments, in the surgery database. Normally, in a raw image data spreading over various frames and time space, it is required to select and freeze those frames, which contain tool and tissue data. For instance, in an incision procedure involving the abdomen tissue, manipulation on a raw sample video of 60 minutes of surgical procedure, having frames 24 frames/second, the total number of frames of the raw video that need to be reckoned will be 86400 frames. In order to process or manipulate these frames in real time, at 800×600 resolution, 41.4 billion iterations (60 minutes×60 seconds×24 frames×800 pixels wide×600 pixels height) of pixel data are required.

However, in the method of the present invention, where fragmentation of the raw video file is undertaken, the above-mentioned parameters are manipulated, specifically scanning the selected frames of the fragmented raw video file, to identify only the instances of the appearance of the incision tool. Applying the aforementioned raw video file values here, the manipulation results in about 57.6 million iterations (05 seconds×24 frames×800 pixels wide×600 pixels height). Consequently, by adopting the process of fragmentation of the method of the present invention, the total time taken for scanning all the frames of the fragmented video file is reduced by about million times as compared with the scanning of raw video data, for tool tracking. Further, by adopting the fragmented frames repetitive iterations are avoided as in the case of raw video frames.

### Stage 3—Benchmark Database

A benchmark database is incorporated with standardized parameters, based on the manipulation of tissues of the subject, in conjunction with the surgical tool, by the practitioner. The elements of benchmark database are based on the inputs obtained from a panel of experts having domain expertise in the field of tissue manipulation. The elements of benchmark database that are reckoned to provide rankings for the Tissue Manipulation Event include length of tissue manipulation, number of tissue-touch attempts, time taken to accomplish the tissue manipulation, extent of deviation of tissue manipulation, complications associated with the extent of deviation in tissue manipulation etc.

As an exemplary embodiment, the benchmark database as shown below is provided with standardized parameters such as type of organ of the subject selected for surgery, extent of organ exposure, surgical parameters such as length and shape of incision, deviation limits, complications associated deviations, number of tissue touch attempts and standardized benchmark rankings or scoring.

BENCHMARK DATABASE

| | | ORGAN | SHAPE OF | | COMPLI- | TTA | BENCHMARK | |
|---|---|---|---|---|---|---|---|---|
| TME | LENGTH | EXPOSURE | MANIPULATION | DEVIATION | CATION | COUNT | TIME | SCORING |
| ABDOMEN | 10 CMS | 10 CMS | STRAIGHT | 1-1.5 mm | — | 1 | 5 Sec | 1 |
| INCISION | | LENGTH/ | | | | | | |
| | | 4 CMS | | | | | | |
| | | WIDTH AT | | | | | | |
| | | RETRACTION | | | | | | |
| ABDOMEN | 15 CMS | | CURVED | 6 mm | 7 mm/TISSUE | 6 | 25 Sec | 9 |
| INCISION | | | | | DAMAGE | | | |

### Stage 4—Tool and Tissue Verification Steps

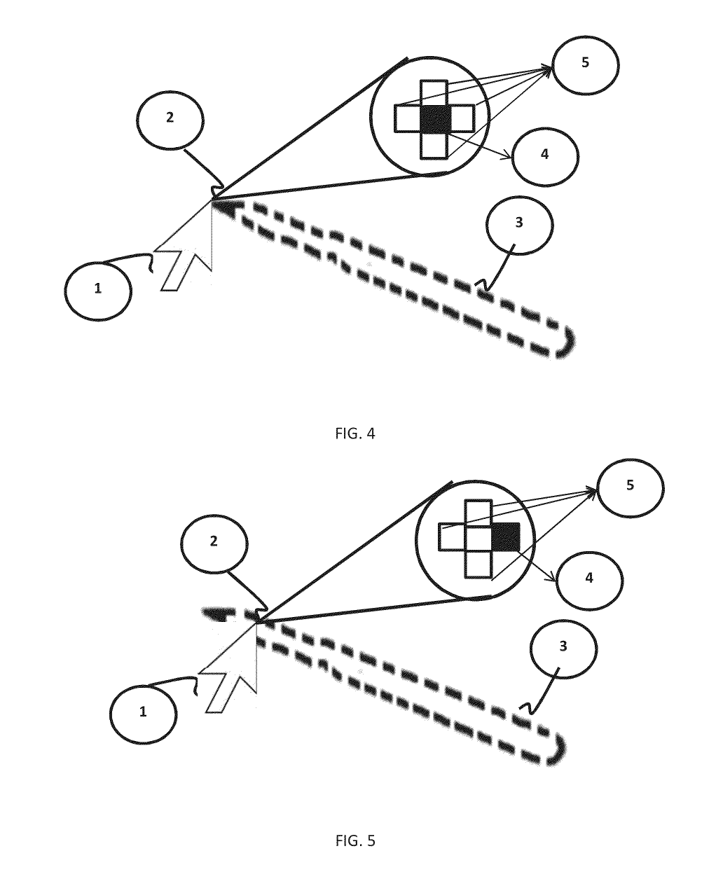

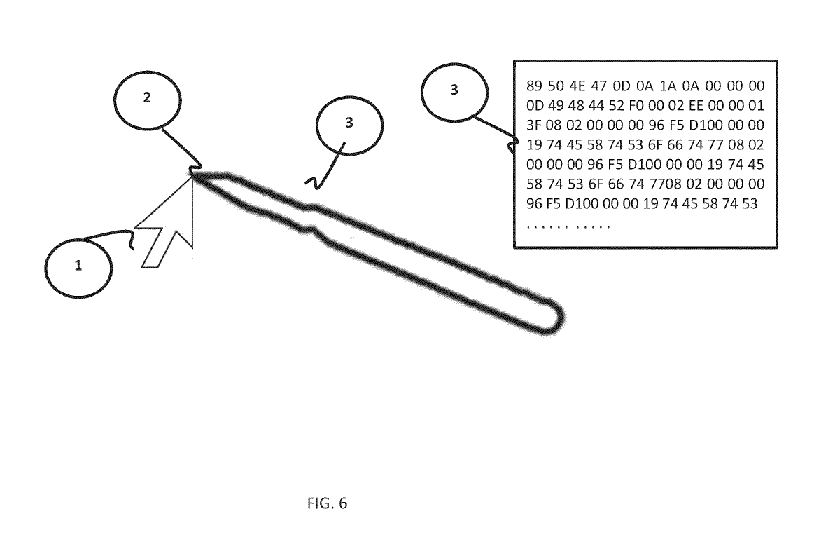

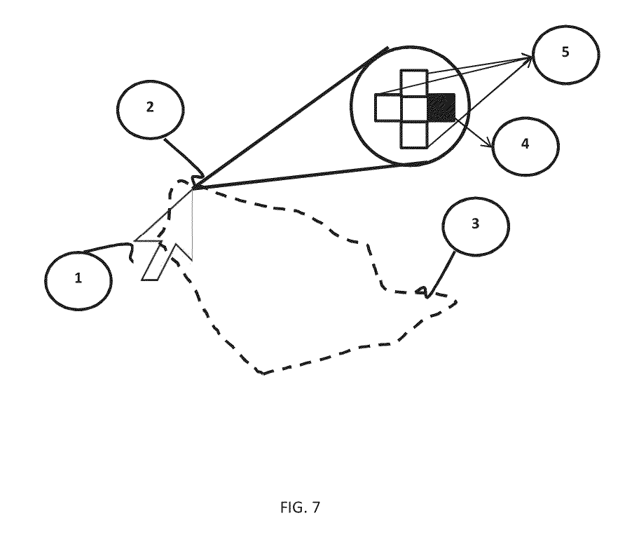

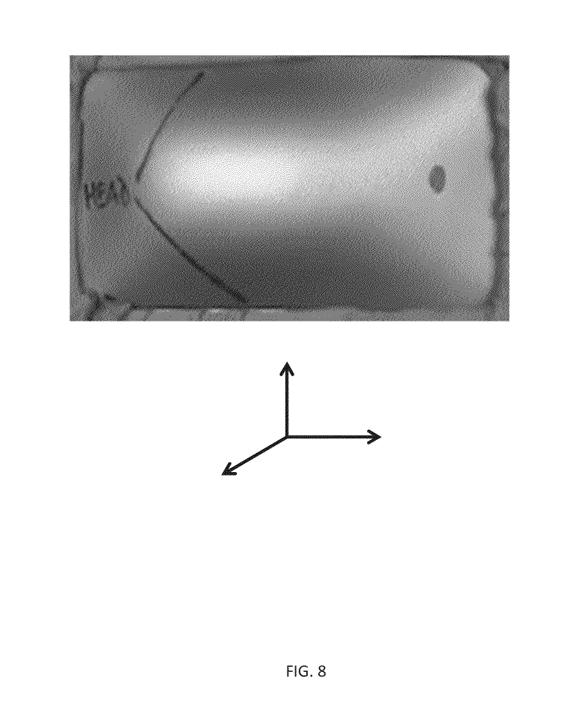

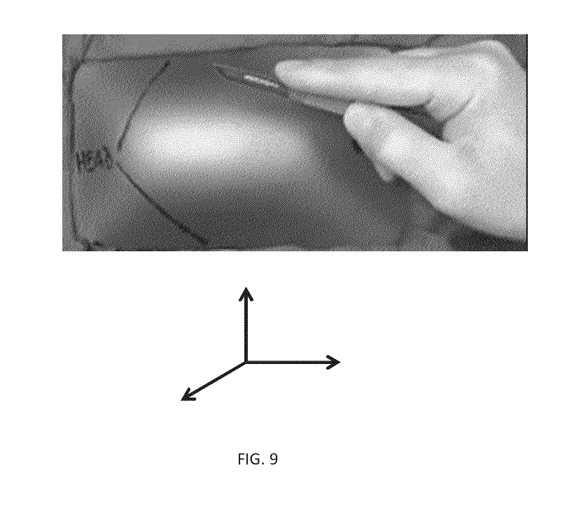

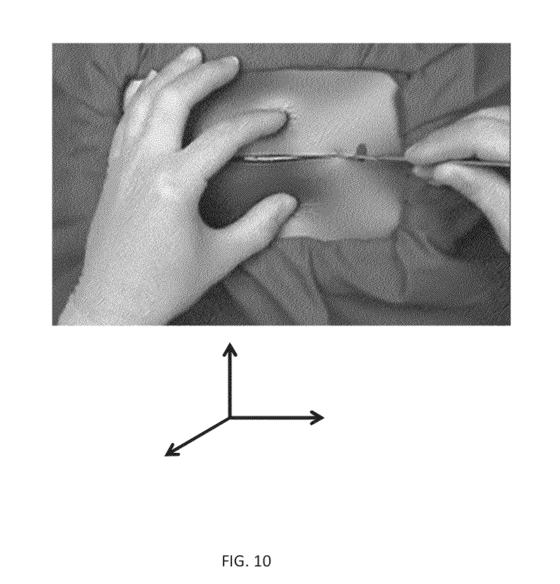

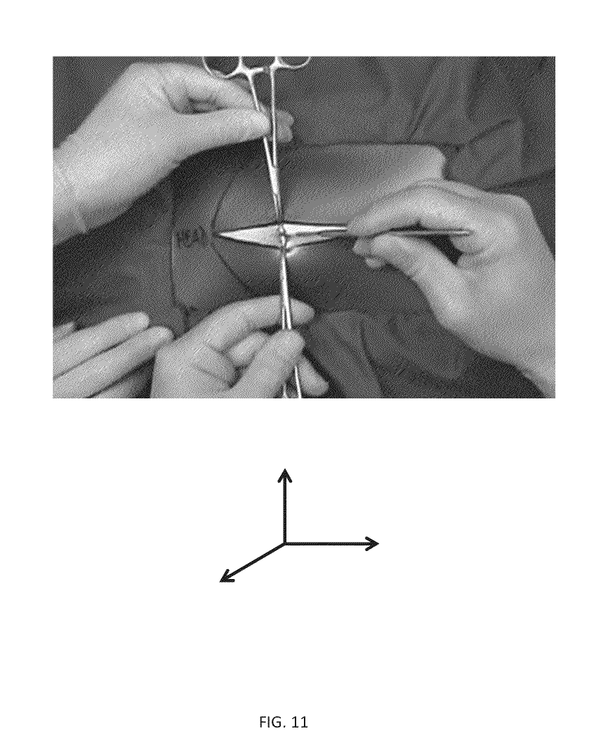

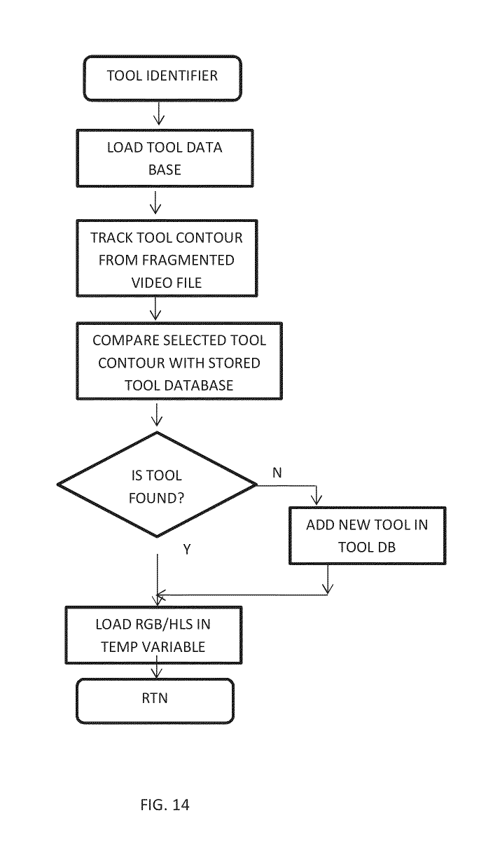

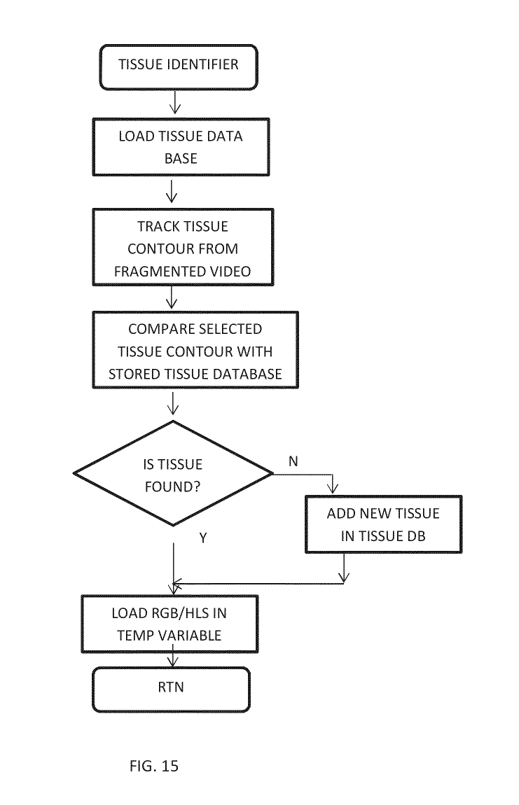

Tool identification steps of the method of the present invention are performed using the fragmented video frames, as shown in FIGS. 4, 5, 6 and 7 in accordance with flow diagrams of FIGS. 14 and 15.

In order to identify the tool as used in the video image, which stands converted into pixelated format, a movable pointer is used to focus on the selected images of the tool.

The contour determination of the selected tool is performed in the following manner. The pointer which is pointed to a pixel of the tool image is considered as first pixel for contour determination. Thereafter, the characteristics of the selected pixel are determined (RGB, HLS) and search is conducted in the neighborhood of the selected pixel to identify an adjacent pixel with identical characteristics (RGB, HLS), corresponding to the previously selected pixel. Once the adjacent pixel is considered as having identical characteristics of the first pixel, this pixel would assume the role of the first pixel for subsequent pixels. This process of iteration is continued on the selected pixelated image of the tool, till the pointer reads all the occurrences of the identical pixels, till the pointer reaches the starting point or pixel.

The resultant pixel data concerning the selected tool are synchronized such as by auto-sizing, in order to match with the contour vector data of the corresponding bench-marked tools, as stored in tool database.

TOOL DATABASE

| Tool | RGB | HLS | Contour Vector | Tool Function |
|---|---|---|---|---|
| Scalpel | 106, 46, 45 | 6, 45%, 28% | 89 50 4E 47 0D | Incision, |
| | 92, 28, 29 | 2, 46%, 34% | 0A 1A 0A 00 | Separation |
| | 121, 110, 65 | 6, 48%, 30% | 00 00 0D 49 48 | |
| | | | 44 . . . | |
| Forceps | 88, 81, 62 | 5, 28%, 16% | 2B 0A 00 00 01 | Dissection |
| | 85, 76, 61 | 7, 14%, 8% | 02 1B 2B 1C . . . | |

Simultaneously, the tissue characteristics of the selected subject are also captured, and stored in the same manner as it is done for the identification of the external contours of the selected surgical device.

TISSUE DATA BASE

| Tissue | RGB | HLS | Contour Data |
|---|---|---|---|
| Abdomen | 27, 34, 27 | 18%, 11%, 11% | #1b221b |
| Tissue | 3, 2, 1 | 4%, 0%, 100% | #020100 |
| | | | . . . |
| Eye/Sclera | 0, 2, 1 | 26%, 0%, 33% | #010101 |
| | 1, 1, 1 | 18, 0%, 33% | #020101 |
| | | | . . . |

### Stage 5—Tissue Manipulation Tracking

In this method, as an exemplary embodiment, the benchmark database is provided with rankings for Tissue Manipulation Events (TMEs). TMEs include incision, retraction, cauterization, heamostasis, diathermy, dissection, excision, injection, implantation, surface marking and other similar tissue manipulations. The exemplary TME considered in this context is a procedure for an incision in an abdomen area of the subject provided with an initial point A and terminal point B. In case, the practitioner performs the incision from Point A to Point B, with a single tissue-touch attempt and in straight line from point A to point B, as shown in FIG. 12, in a given time of 5 seconds, without any deviation from the designation path, the highest ranking for the TME is provided.

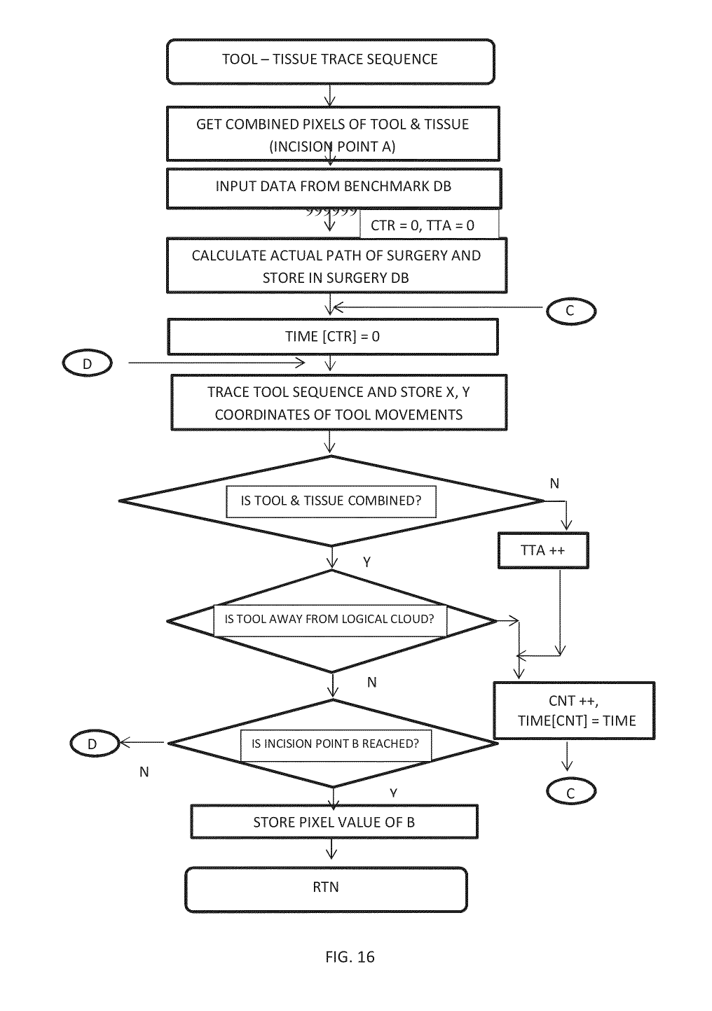

In this method as shown in flow drawing (FIG. 16), initially a combined pixel data of tool and tissue at the point A are recorded. At this point of time, a counter for TTAs is initialized as zero (0). The capture of the combined pixel data of tool and tissue is continued to obtain the tool path and the distance travelled from point A. The captured values are stored. As long as the combined pixel data is made available, the status of the tool is designated as in touch condition with the tissue. In the absence of tool data from the combined pixel data the status of the tool is designated as “tool-up”. At this point the count of the counter for TTA is incremented by 1. If the tool-up event in this case does not recur while travelling from point A to B, the ranking for TME is rated as one.

Similarly, if there are more number of tissue-touch attempts made by the practitioner, the corresponding ranking for TME is also varied. For instance, if the user while performing the surgical procedure lifts the surgical device from the tissue while moving between the points A and B, and touches the tissue more than once en route, such repeated tissue-touch attempts are tracked and recorded. The ranking score in such a scenario is suitably altered.

The method of the present invention also measures the extent of deviation from a pre-determined path of a surgery. In the given exemplary embodiment the TTAs are measured for a surgery from point A to B, under an ideal and optimum condition of straight line of incision. However, in a scenario, where there is a need to evaluate the occurrence of deviation, if any, from a pre-designated surgical path, by the practitioner, it is essential to track the extent of such deviation.

Accordingly, in the method of the present invention, a designated logical cloud is created around the Point A. The logical cloud is provided a capability to scan and capture the RGB combination of the pixels falling under the area of the logical cloud. The surgical path that is the pixel combination, which form the straight line between the points A and B, will have a specific combination of RGB values. Along the path of incision, during the course of surgery, a fixed set of unique RGB values are created. Similarly, when the practitioner takes a deviation, a corresponding set of another RGB values are created, which are different in composition as compared to the pixel combination of the tissue along the original surgical path. The difference in the pixel data is used to identify the extent of deviation and compared with standard benchmark data for the purpose of ranking.

In this context, when the practitioner performing the surgery with a tool, deviates from this straight line, into an adjacent area, the logical cloud identifies the difference in nature of RGB combination between the pixels of straight line the deviated areas.

The method of the present invention also provides for measuring the deviation beyond the benchmarked area and the ranking is provided accordingly.

The method of the present invention also identifies the extent tissue retraction, during the course of surgery and ranking the associated skills thereof.

### Stage 6—Time Calculation

In addition to the consideration of events such as TTA, deviation from the pre-defined path etc., for the purposes of TME ranking, the method of the present invention also considers the aspect of time to complete the given surgery. A time counter TC is provided, which is actuated upon the commencement of surgical procedure from a starting point and the time take to reach a destination point is recorded. The method of the present invention also determines the intervening time taken by the practitioner between the tool-up time and returning to resume the surgical procedure, either with the same tool or a different one.

### Stage 7—Display of Measured Parameters

The measured parameters such as number of TTAs, time taken, the length and extent of the surgical area, are displayed to the user. These parameters are evaluated by a panel of experts before a final ranking is rendered.

### Stage 8—Display of Ranking

Once the ranking score is determined based on the execution of the above-mentioned steps, the same is displayed.

The embodiments for TMEs as shown in the present invention are exemplary in nature and the method and system of the present invention can be suitably adapted to consider any other TME.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the appended claims.

Although the embodiments herein are described with various specific embodiments, it will be obvious for a person skilled in the art to practice the embodiments herein with modifications.

It is also to be understood that the following claims are intended to cover all of the generic and specific features of the embodiments described herein and all the statements of the scope of the embodiments which as a matter of language might be said to fall therebetween.

1. A system comprising:
(a) contour image capturing and recording devices adapted to capture and record, in real time, the contours of a surgical tool and a tissue and tissue manipulating events of a subject;
(b) a data receiver for receiving vector image date from said contour image capturing and recording devices;
(c) at least a database including bench-mark surgical parameters; and
(d) a processor coupled to the data receiver and the database and configured to convert the vector image data into pixelated frames, evaluate tissue manipulation events and generate a performance score for the task performed on the subject.

2. The system of claim 1, wherein the in contour image capturing and recording devices record images in a digital video format.

3. The system of claim 1, further including an output device coupled to the processor.

4. The system of claim 1, wherein the output device includes at least a printer, a display, a transmitter and a network interface.

5. (canceled)

6. (canceled)

7. The system of claim 1, wherein said image capturing and recording devices are positioned at various angles, preferably two devices substantially perpendicular to each other.

8. The system of claim 1, wherein said processor is a digital processor which is loaded with a tool identifier module, a tissue identifier module and a tissue manipulation events module.

9. The system of claim 1, wherein an additional audio-visual complication correcting and suggesting mechanism is incorporated.

10. A method for evaluation of manual skills in a tissue manipulating event, comprising:
(a) identifying and digitizing contour-based physical characteristics of a surgical tool and a tissue of a subject from a pixelated identifiable fragments of vector data;
(b) executing tool-identifier and tissue-identifier modules on the pixelated identifiable fragments;
(c) executing a tissue manipulation tracer module on the pixelated identifiable fragments;
(d) executing a surgical path deviation identification module; and
(e) displaying a skill-ranking profile of the practitioner on the tissue manipulation of the subject.

11. The method according to claim 10, wherein elements to provide rankings for a Tissue Manipulation Event include length of tissue manipulation, number of tissue-touch attempts, time taken to accomplish the tissue manipulation, extent of deviation of tissue manipulation and complications associated with the extend of deviation in tissue manipulation.

12. The method according to claim 10, wherein in order to identify the tool a movable pointer is used to focus on selected images of the tool.

13. The method according to claim 10, wherein in order to identify a deviation a logical cloud is used.

14. A computer readable medium having a set of instructions stored thereon for causing a computer to implement a method according to claim 10.
